(19) United States
(12) Patent Application Publication
(10) Pub. No.: US 2023/0210636 A1
(43) Pub. Date: Jul. 6, 2023

(54) FORCE-DIRECTING DENTAL ALIGNER ATTACHMENTS

(71) Applicant: Align Technology, Inc., San Jose, CA (US)

(72) Inventors: Avi KOPELMAN, Palo Alto, CA (US); Jun SATO, San Jose, CA (US); Jessica SCHILTZ, San Jose, CA (US); Tzishing Jesse LIM, Mountain View, CA (US); John Y. MORTON, San Jose, CA (US)

(21) Appl. No.: 18/149,030

(22) Filed: Dec. 30, 2022

Related U.S. Application Data
(60) Provisional application No. 63/295,448, filed on Dec. 30, 2021.

(51) Int. Cl. A61C 7/08

(52) U.S. Cl. CPC A61C 7/08

(57) ABSTRACT

Described herein are attachments for an orthodontic appliance, such as an aligner, that include a base region configured to be rigidly mounted to a tooth surface and an interface surface region that is configured to engage with the orthodontic appliance, in which the base region and the interface surface region are movably connected. These attachments may be configured as force applying attachments and/or as force redirecting attachments. Also described herein are modular attachments.

### CLAIM OF PRIORITY

This patent application claims priority to U.S. Provisional Pat. Application No. 63/295,448, titled “FORCE-DIRECTING DENTAL ALIGNER ATTACHMENTS,” filed on Dec. 30, 2021, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

The method and apparatuses described herein generally to the field of orthodontics, and more particularly to tooth attachments for engaging a dental repositioning appliance, the attachments capable of redirecting or applying forces different from those applied passively by the orthodontic appliance for improved application of a desired force system to elicit the identified tooth movement.

An objective of orthodontics is to move a patient’s teeth to positions where function and/or aesthetics are optimized. Traditionally, appliances such as braces are applied to a patient’s teeth by an orthodontist or dentist and the set of braces exerts continual force on the teeth and gradually urges them toward their intended positions. Over time and with a series of clinical visits and adjustments to the braces, the orthodontist adjusts the appliances to move the teeth toward their final destination.

More recently, alternatives to conventional orthodontic treatment with traditional affixed appliances (e.g., braces) have become available. For example, systems including a series of preformed aligners have become commercially available from Align Technology, Inc., San Jose, Calif., under the tradename InvisalignⓇ System. The InvisalignⓇ System is described in numerous patents and patent applications assigned to Align Technology, Inc. including, for example in U.S. Pat. Nos. 6,450,807, as well as on the company’s website, which is accessible on the World Wide Web (see, e.g., the URL “align.com”). The Invisalign® System includes designing and/or fabricating multiple, and sometimes all, of the aligners to be worn by the patient before the aligners are administered to the patient and used to reposition the teeth (e.g., at the outset of treatment).

Orthodontic appliances and systems often make use of tooth attachments or components bonded to the surface of a tooth in order to elicit a desired tooth movement. Appliances, in general, apply force and/or torque on a tooth crown to move teeth, with the applied force typically normal with respect to the surface of a tooth or attachment positioned on the tooth. Currently, orthodontic systems typically use a number of generic or standard attachments to accomplish orthodontic tooth movement. These attachments are typically static. A tooth movement may be identified, and then a generic or standard attachment is selected for use in connection with a repositioning appliance. Selection and positioning of the attachment is typically accomplished based on clinical experience or at the discretion of the treating professional. Unfortunately, such approaches are not optimal. Due to the individual morphology of teeth and composite movements, the performance of such attachments may not be optimal for all patients.

Accordingly, improved techniques and orthodontic systems are needed for designing and providing more effective tooth movement forces to the teeth during orthodontic treatment using tooth attachments and reducing unwanted tooth movements.

### SUMMARY OF THE DISCLOSURE

Described herein are methods and apparatuses (e.g., systems and devices, including attachments) for applying additional force and/or for redirecting force applied by an orthodontic appliance such as, but not limited to, an orthodontic shell aligner (“aligner”) and/or a palatal expander. Although the majority of the examples provided herein apply to orthodontic shell aligners, it should be understood that these apparatuses may be used with other orthodontic appliances that include a cavity or channel for holding the patient’s teeth, and which are configured to engage an attachment affixed to the patient’s teeth. Also described herein are method for using the attachments described herein and/or methods of creating a treatment plan using one or more of these attachments, and/or methods of moving teeth using these attachments, in combination with one or more (e.g., a series) of aligners.

In general, the apparatuses described herein comprise tooth attachments that are configured to be bonded to a tooth and to couple to an orthodontic appliance and actively apply and/or redirect force between the tooth and the orthodontic appliance. In some examples the attachment, which may be referred to as an active attachment for convenience herein, may include a base for statically attaching to the tooth and an orthodontic appliance engaging region, which in some examples may be an interface surface; the base and the orthodontic appliance engaging region are coupled together so that the orthodontic appliance engaging region may move in a prescribed manner relative to the base, and may redirect force from the orthodontic appliance and/or may apply supplemental force.

The active attachments described herein may dramatically expand the types and directions of movements available to treat a subject’s teeth using an orthodontic appliances in ways that may not be possible using a static attachment and an orthodontic appliance. In addition, the active attachments described herein may be self-contained and are significantly easier to use as compared with orthodontic elastics or rubber bands that need to be applied and/or removed by the subject. Further, the active attachments described herein may be used to provide directions of movement (e.g., rotational movement, etc.) that are not readily achievable using orthodontic elastics. These apparatuses and methods may also provide significantly more predictable movements, and, as described herein, may be incorporated into a subject’s treatment plan.

For example, described herein are attachments having multiple connected parts that may be applied to the tooth and may actively apply forces to the teeth in addition to (or instead of) forces applied by an aligner attached to the teeth. Also described herein are attachments that are configured to redirect forces applied to the teeth by an aligner that is coupled to the attachments. In general, any of these attachments may be part of a system for aligning the teeth including one or more of these attachments or combination of these attachments.

In some examples the attachments may comprise multiple parts, including a base portion or region (“base”) that is configured to be rigidly attached to the surface of a tooth, and an interface surface portion or region (e.g., cover) that is configured to engage (or be engaged by) an orthodontic appliance. Any of these appliances may include an actuator movably coupling the base to the interface surface. The actuator may generate a force between the interface surface and the base. Thus, the actuator, examples of which are provided herein, may apply a force to move (translate, rotate, tilt, etc.) a tooth even when used with an aligner that provides no or minimal force on the tooth to which the attachment is attached. The ability to apply forces independently of, and in some cases in directions and at locations that may be difficult or impossible to achieve by the orthodontic appliance itself is highly advantageous and allows for orthodontic treatments that were previously not possible or not readily achievable within a desired treatment time.

Any of these appliances may also or alternatively include a force-redirector, which includes a force-redirecting surface, between the base and the interface surface. In some examples the force-redirector may transmit and redirect the force applied by an orthodontic appliance in a different direction and to a specific location on a tooth. In some examples the force-redirector (e.g., force-redirecting surface) may redirect some or all of the force back to the orthodontic appliance, which may modify the effect of the orthodontic appliance on the tooth or teeth. Any of these attachments may be configured so that the base is movably coupled to the interface surface through the force-redirector so that a first force applied against the interface surface by the orthodontic appliance is redirected by the force-redirector (e.g., force-redirecting surface) so that it is applied as a second force against the base or the interface surface in a different direction than the first force. Examples of force-redirectors are described herein, and may include force-redirecting surfaces such as ramps, cams, gears, levers, etc.

Any of the attachments described herein may be configured to include both a force-redirecting surface and an actuator, which may both add additional force from the actuator arising from the attachment and may also redirect force applied by the orthodontic appliance by moving the actuated component relative to the base. The base may be rigidly affixed to the tooth and may be configured to confirm to the surface of the patent’s teeth. For example the base may be customized to a particular tooth surface of a specific patient. Alternatively the base may be configured to generally confirm to a variety of different teeth. The base may be formed by 3D printing and/or formed of a dental composite.

In general, the attachments described herein may be pre-fabricated, e.g., by 3D printing, and may include multiple parts or portions corresponding to the base part that is configured to couple to a tooth or teeth, and an interface surface part that is configured to engage with the orthodontic appliance (e.g., aligner). The reciprocating parts may be joined with either or both the actuator and/or the force-redirector (e.g., force redirecting surface). The interface surface and the base may interact with each other in different ways to apply and/or redirect force to move a tooth or teeth, as described herein. A force-redirector may divert the direction of the force from the orthodontic appliance (e.g., aligner), for example, the force-redirector may push the attachment towards the incisal edge but the force on the tooth is in distal direction. In any of these apparatuses (devices, systems, etc.) the portions of the attachments (e.g., base, retainer and/or actuator, and interface surface, etc.) may be fabricated together.

The attachment may increase or decrease the force (e.g., by gearing). For example, while the orthodontic appliance (e.g., aligner) moves the attachment 0.5 mm, the tooth may move 0.75 mm. The attachment may split the force into two or more directions, for example, one contact point with the aligner may generate two (or more) forces on the tooth in desired directions, which may include a rotation force, forces in opposing directions to generate bodily movements and more.

Attachments including an actuator may include an elastic actuator between the base and the interface surface. In some examples the actuator may be a shape memory material (e.g., a shape memory alloy such as Nitinol), which may be both super elastic but may also transition to a memorized shape (e.g., transitioning between martensitic and austenitic configurations as the temperature changes); the shape memory may be used to drive actuation of the actuator. For example, the aligner may hold the attachment in a static position and the force on the tooth will be generated from the nickel titanium parts that connects the two parts of the attachment. The attachment may include a compliant mechanism (e.g., a flexible mechanism that achieves force and motion transmission through elastic body deformation). A compliant mechanism for the attachment (e.g., for the actuator) may be made from one part and still provide the advanced functionality described herein.

In general, the attachments described herein may be very small in size; however, as mentioned above, these attachments may generate forces in directions and of types that cannot be achieved today.

In some examples the attachment may include one or more components made of a ceramic or other dental composite material. In general, the design of the attachment may be optimized so that the mechanical interface with the aligner (e.g., the interface surface) may make insertion and removal of the aligner easier. These attachments may be made in a variety of different dental colors and shades, e.g., using the Vita shade guide (see, e.g., https://www.vitazahnfabrik.com/en/VITA-shade-guides-31233,98477.html, last visited Dec. 25, 2021).

Described herein are attachments (e.g., “active attachments”) for an orthodontic appliance that couple an orthodontic appliance (e.g., an aligner, palatal expander, etc.) to a tooth at a contact point. The orthodontic appliance may include an engagement site (cavity, opening, channel, clip, etc.) that couples to the attachment, and in particular that couples to the movable engagement surface of the attachment, as described in greater detail herein.

Thus, described herein are attachment for an orthodontic appliance that include: a base configured to be rigidly mounted to a tooth surface; an interface surface movably coupled to the base, wherein the interface surface comprises an outer surface configured to removably engage with an orthodontic appliance to be worn on a patient’s teeth; and a retainer securing the base and the interface surface together while permitting movement of the interface surface relative to the base, wherein a force applied to the interface surface from the orthodontic appliance is transformed by the relative movement of the interface surface and the base.

In any of the apparatuses described herein the interface surface may be part of a cover or housing. The interface surface may be coupled to the base via the actuator. The interface surface may at least partially cover or enclose the attachment, e.g., the base and/or actuator of an active attachment, while being configured to move relative to the base.

The retainer may comprise an actuator, wherein the actuator is coupled to the base and to the interface surface, further wherein actuating the actuator moves the interface surface relative to the base. In some examples, the attachment may include an actuator (e.g., mechanical actuator) that is separate from the retainer. For example the attachment may include comprising an actuator, wherein the actuator is coupled to the base and to the interface surface, further wherein actuating the actuator moves the interface surface relative to the base.

The actuator may comprise one or more of: a shape-memory material, one or more gears, a spring, a thermal bimorph, and a piezoelectric. The actuator may be movably coupled to the base and/or to the interface surface.

In some examples the retainer comprises a force redirector between the base and the interface surface, wherein the base is movably coupled to the interface surface through the force-redirector so that a first force applied against the interface surface by the orthodontic appliance is redirected by the force-redirector so that it is applied as a second force against the base or the interface surface in a different direction than the first force.

Alternatively, in some examples the attachment includes a force redirector that is separate from the retainer.

The force redirector may include one or more force redirecting surfaces. The force redirector may comprise one or more of: a ramp, a cam surface, a lever, and one or more gears. Any of these attachments may include a bias coupled to the force redirector to modify the first force.

In any of these apparatuses, the outer surface may comprise an outer housing that is configured to engage with a site on the orthodontic appliance.

Described herein are force applying attachments that are configured to apply a force from within the attachment, e.g., through an actuator within the attachment. For example, an attachment for an orthodontic appliance may include: a base configured to be rigidly mounted to a tooth surface; an actuator coupled to the base; and an interface surface coupled to the actuator, wherein the interface surface comprises an outer surface configured to removably engage with an orthodontic appliance to be worn on a patient’s teeth, further wherein actuating the actuator moves the interface surface relative to the base.

Any appropriate actuator may be used. These actuators may be referred to as mechanical actuators because they apply a mechanical force to drive movement of a tooth or teeth. Examples of actuators include actuators based on a shape-memory material (e.g., a nitinol member), one or more gears, a spring, a thermal bimorph, and a piezoelectric. In general, the actuator may be movably coupled to the base. The actuator may be movably coupled to the interface surface. The attachment may include one or more bearing surfaces within either or both the interface surface and the base.

An actuator may be automatically or manually actuated or triggered. For example, the actuator may be actuated by a change in temperature (e.g., when worn in the patient’s mouth), or by the application of an external electric or magnetic field. In some examples the actuator is actuated by the application of an external (e.g., RF, ultrasound, etc.). In some examples the actuator is automatically actuated. For example, the actuator may include one or more biases that apply a force over time while wearing the orthodontic appliance. For example, the actuator may transition to a biased configuration after being attached to the tooth/teeth and applying the orthodontic appliance.

The outer surface may comprise a rigid outer housing that is configured to engage with an engagement site on the orthodontic appliance.

The attachments described herein may be part of a system including an orthodontic appliance. For example, also described herein are systems comprising: an orthodontic appliance; and an attachment, the attachment comprising: a base configured to be rigidly mounted to a tooth surface; an interface surface movably coupled to the base, wherein the interface surface comprises an outer surface configured to removably engage with an orthodontic appliance when the orthodontic appliance is worn on a patient’s teeth; and a retainer securing the base and the interface surface together while permitting movement of the interface surface relative to the base, wherein a force applied to the interface surface from the orthodontic appliance is transformed by the relative movement of the interface surface and the base.

In some examples, the system may include: an orthodontic appliance; and an attachment, the attachment comprising: a base configured to be rigidly mounted to a tooth surface; an actuator coupled to the base; and an interface surface coupled to the actuator, wherein the interface surface comprises an outer surface configured to removably engage with an orthodontic appliance to be worn on a patient’s teeth, further wherein actuating the actuator moves the interface surface relative to the base.

These systems may include any of the features of the attachments described herein.

Also described herein are method of moving teeth in a patient using a force-applying attachment. For example, a method may include: attaching a patient’s teeth into a tooth-receiving channel of a dental aligner so that the dental aligner engages with an interface surface of a force-applying attachment on the patient’s teeth; and applying a force to move one or more of the patient’s teeth, where the force includes a first force applied by an actuator within the force-applying attachment, wherein a base of the force-applying attachment is mounted to a tooth surface and wherein the base is coupled to the actuator and the actuator is coupled to an interface surface of the force-applying attachment so that the actuator applies force between the interface surface and the base.

Any of these methods may also include attaching the force-applying attachment to the tooth surface so that the base is rigidly mounted to the tooth surface. Attaching the patient’s teeth into the tooth-receiving channel of the dental aligner may comprise coupling the dental aligner to a plurality of force-applying attachments mounted on the patient’s teeth. In some examples applying the force to move one or more of the patient’s teeth comprises applying a second force from the actuator in combination with the first force from the actuator.

The first force may be configured to move the one of the patient’s teeth in rotation. The first force may be configured to move the one of the patient’s teeth in tilting.

Also described herein are methods of generating a treatment plan including a force-applying attachment. For example, a computer-implemented method for designing a customized tooth movement system for moving a tooth of a patient may include: determining a targeted force configured to elicit a selected movement when applied to the patient’s tooth; selecting a digital model of a force-applying attachment configured to engage an orthodontic shell appliance; determining a first force that would be applied to the patient’s tooth by wearing the orthodontic shell appliance; determining a second force that would be applied to the patient’s tooth by engagement of the force-applying attachment with the orthodontic shell appliance; determining an applied force from the first force and the second force; and modifying one or more parameters of the force-applying attachment and/or the orthodontic shell appliance so that the applied force approximates to the targeted force.

Any of these methods may include receiving a digital model of the patient’s teeth. Any of these methods may include generating a digital model of the orthodontic shell appliance.

The same treatment plan may include using multiple attachments in the same stage and/or different stages. For example, the methods described herein may include repeating the steps of selecting the digital model, determining the first force, determining the second force, determining the applied force and modifying the one or more parameters for multiple teeth. In some examples, the method may include repeating the steps of selecting the digital model, determining the first force, determining the second force, determining the applied force and modifying the one or more parameters for multiple stages of a dental treatment plan.

Modifying one or more parameters of the force-applying attachment and/or the orthodontic shell appliance may include selecting an actuator within the force-applying attachment. Selecting the actuator may comprise selecting a shape-memory force applying attachment.

Also described herein are force-redirecting attachments. For example an attachment for an orthodontic appliance may include: a base configured to be rigidly mounted to a tooth surface; an interface surface configured to couple to an orthodontic appliance to be worn over a patient’s teeth; and a force redirector (e.g., including a force-redirecting surface) between the base and the interface surface, wherein the base is movably coupled to the interface surface through the force-redirecting surface so that a first force applied against the interface surface by the orthodontic appliance is redirected by the force redirector (e.g., a force-redirecting surface) so that it is applied as a second force against the base or the interface surface in a different direction than the first force.

The force redirector may include a simple machine, such as a ramp, lever, etc. Any of the force redirectors described herein may include a force-redirecting surface and may therefore be referred to as a force-redirector. For example, a force redirector (e.g., force-redirecting surface) may include a cam surface. The force-redirecting surface may comprise a lever. The force-redirecting surface may comprise one or more gears. Any of these apparatuses may include a bias coupled to the force-redirecting surface to modify the first force. The force-redirecting surface may include one or more bearing surfaces coupled to either or both the interface surface and the base.

The interface surface may include a rigid outer housing that is configured to engage with an engagement site on the orthodontic appliance. In some examples the interface surface comprises an elastic outer housing that is configured to engage with an engagement site on the orthodontic appliance. The second force may be directed at an angle of between about 5 degrees and 175 degrees (e.g., between 10 degrees and 170 degrees, between 15 degrees and 165 degrees, etc.) relative to the first force. The resultant force may be directed at an angle or arch that can be supplementary or complementary to the designed direction of the initial or first applied force, and the angles may sum to 180 and 90 for supplementary and complementary configurations, respectively.

Also described herein are methods of moving teeth in a patient using a force-applying attachment. For example, a method may include: attaching a patient’s teeth into a tooth-receiving channel of a dental aligner so that the dental aligner engages with an interface surface of a force-redirecting attachment on the patient’s teeth; and applying a first force from the dental aligner to an interface surface of the force-redirecting attachment in a first direction; redirecting the first force applied from the dental aligner by moving a first surface coupled to the interface surface relative to a force-redirecting surface that is coupled to a base of the force-redirecting attachment to apply a second force to a tooth to which the base of the force-redirecting attachment is attached, wherein the second force is in a different direction than the first force. In general, an attachment may engage with an aligner (e.g., as part of an attachment well or cavity) in a surface of plane of the force-redirecting attachment couple to the patient’s tooth, which may result in a force (and in some cases movement) being applied.

Moving the first surface relative to the force-redirecting surface may include moving the first surface along a ramp. In some examples moving the first surface relative to the force-redirecting surface may include moving the first surface along a cam surface. Moving the first surface relative to the force-redirecting surface may comprise moving the first surface against a lever. In some examples moving the first surface relative to the force-redirecting surface comprises moving the first surface to drive one or more gears.

Any of these methods may include biasing the first surface or the force-redirecting surface to modify the first force. The second force may be directed at an angle of, e.g., between 5 degrees and 175 degrees (e.g., between 10 degrees and 170 degrees, between 15 degrees and 165 degrees, etc.) relative to the first force.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1A schematically illustrates an exploded view of one example of an attachment as described herein.

FIG. 1B schematically illustrates one example of the attachment of FIG. 1A.

FIGS. 2A-2B illustrate one method of using an attachment (e.g., a force-applying attachment) as described herein. FIG. 2A shows the attachment applied to a tooth prior to actuation (and prior to coupling to an orthodontic appliance, e.g., aligner). FIG. 2B shows the attachment actuated and applying force from an actuator within the attachment when the attachment is engaged with an orthodontic appliance (e.g., aligner)

FIGS. 3A-3C illustrate examples of a base region (FIG. 3A), actuator (FIG. 3B) and interface surface region (FIG. 3C), respectively.

FIGS. 4A-4C illustrate an example of an attachment similar to that shown by the assembly of FIGS. 3A-3C with the base rigidly attached to a tooth (FIG. 4A), after coupling the actuator (FIG. 4B), and after coupling the interface surface (FIG. 4C).

FIGS. 5A and 5B illustrate operation of one example of an attachment as described herein.

FIG. 6 illustrates one method of moving a tooth using an attachment as described herein.

FIG. 7 illustrates an example of the application of an orthodontic appliance to engage with a patient’s teeth including attachments as described herein.

FIGS. 8A-8B illustrate one example of the operation of a force applying attachment as described herein.

FIGS. 9A and 9B illustrate one example of a force-redirecting attachment as described herein.

FIGS. 10A and 10B illustrate another example of an attachment as described herein.

FIG. 11 illustrates an example of a method of using an attachment as described herein to move a tooth.

FIGS. 12A-12D illustrate an example of a modular attachment as described herein.

FIGS. 13A-13C illustrate another example of a modular attachment as described herein.

FIGS. 14A-14C illustrate another example of a modular attachment as described herein.

### DETAILED DESCRIPTION

The tooth attachments (“attachments”) described herein may be used as part of a system and method for modifying the position of one or more of a patient’s teeth. These attachments may be bonded to one or more teeth and may engage with an orthodontic appliance to assist in repositioning of the patient’s teeth. For example, these attachments may be part of an orthodontic systems and related methods for designing and providing improved or more effective tooth movement and for eliciting a desired tooth movement and/or for repositioning teeth into a desired arrangement. Methods and orthodontic systems including the attachments described herein may allow for more effective orthodontic movement. The attachments described herein can be customized to a particular patient (e.g., patient-customized), a particular movement, and/or a sub-group or sub-set of patients and configured to engage an orthodontic tooth positioning appliance worn by a patient. In general, engagement between the attachment and orthodontic appliance may result in the application of a repositioning force or series/system of forces to the tooth having the attachment and will generally elicit a tooth movement.

Orthodontic systems including any of the tooth attachments described herein may include one or more of any of these attachments (e.g., force applying attachments and/or force re-directing attachments and/or modular attachments) and one or more orthodontic appliances (e.g., aligners) that engage the attachments when worn by a patient. The Orthodontic appliances may include teeth receiving cavities that receive and reposition teeth, e.g., via application of force due to appliance resiliency. An exemplary adjustment appliance may be worn by a patient in order to achieve an incremental repositioning of individual teeth in the jaw. The appliance can include a shell (e.g., polymeric shell) having teeth-receiving cavities that receive and resiliently reposition the teeth. Appliances can be designed to engage one or more attachments positioned on a tooth of the patient. These attachments can be designed, oriented, and/or located on a patient’s tooth to precisely control the moments produced on a patient’s tooth as the appliance is worn by the patient. Customized design and use in orthodontic treatment as described herein can advantageously improve effectiveness of treatment and clinical results by more precisely applying force vectors of necessary magnitude and direction for desired movement. Orthodontic systems may include appliances and tooth attachments as described further provide an efficient force distribution mechanism that can more effectively reduce unwanted force and moment.

An attachment may be coupled to a surface of the tooth on the tooth crown and can couple with or engage an orthodontic appliance or aligner when the appliance is worn by the patient. When worn by the patient, the appliance engages the tooth crown and the one or more attachment(s), with interaction/contact between one or more surfaces or portions of the internal cavity of the appliance, and corresponding surfaces/portions of the tooth attachment and/or tooth crown to apply a system of forces for eliciting tooth movement. Various tooth movements can be accomplished, as further noted below.

An appliance can be designed and/or provided as part of a set or plurality of appliances and treatment can be administered according to a treatment plan. Each appliance may be configured so that one or more tooth-receiving cavities has a geometry corresponding to an intermediate or final tooth arrangement intended for the appliance. Appliance geometries can be further designed or modified (e.g., modified to accommodate or operate in conjunction with tooth attachments) so as to apply a desired force or system of forces to the patient’s teeth and elicit a desired tooth movement and gradually reposition teeth to an intended arrangement. The patient’s teeth may be progressively repositioned from their initial tooth arrangement to a final tooth arrangement by placing a series of incremental position adjustment appliances over the patient’s teeth. The adjustment appliances can be generated all at the same stage or in sets or batches, e.g., at the beginning of a stage of the treatment, and the patient wears each appliance until the pressure of each appliance on the teeth can no longer be felt. A plurality of different appliances (e.g., set) can be designed and even fabricated prior to the patient wearing any appliance of the plurality. At that point, the patient replaces the current adjustment appliance with the next adjustment appliance in the series until no more appliances remain. The appliances are generally not affixed to the teeth, and the patient may place and replace the appliances at any time during the procedure. The final appliance or several appliances in the series may have a geometry or geometries selected to overcorrect the tooth arrangement, i.e., have a geometry which would (if fully achieved) move individual teeth beyond the tooth arrangement which has been selected as the “final.” Over-correction may be desirable in order to offset potential relapse after the repositioning method has been terminated, i.e., to permit movement of individual teeth back toward their pre-corrected positions. Over-correction may also be beneficial to speed the rate of correction, i.e., by having an appliance with a geometry that is positioned beyond a desired intermediate or final position, the individual teeth will be shifted toward the position at a greater rate. In such cases, the use of an appliance can be terminated before the teeth reach the positions defined by the appliance.

Orthodontic appliances may impart forces to the crown of a tooth and/or an attachment positioned on the tooth at each point of contact between a tooth receiving cavity of the appliance and received tooth and/or attachment. Thus, the forces applied, both magnitude and direction, may be limited when applying force from the orthodontic appliance alone. Even the use of passive attachments, which provide attachment points for the orthodontic appliance, may be limited in their ability to direct forces to move a tooth or teeth. The magnitude of each of these forces and their distribution on the surface of the tooth determines the type of orthodontic tooth movement which results. Types of tooth movements may include extrusion, intrusion, rotation, tipping, translation and root movement. Tooth movement of the crown greater than the movement of the root is referred to as tipping. Equivalent movement of the crown and root is referred to as translation. Movement of the root greater than the crown is referred to as root movement.

Three examples of attachments are described herein: force applying attachments, force-redirecting attachments, and modular attachments. These are described in greater detail herein. An attachment may be configured to include any or all of the characteristics of force applying, force-redirecting and/or modular attachments.

In general, any of the attachments described herein include a base that is configured to rigidly attach to a tooth or teeth, and an interface surface that engages with the orthodontic appliance (e.g., aligner). The interface surface and base are moveable relative to each other, but are retained together, e.g., by a retainer that holds them together so that they may form a unitary attachment. The retainer may be an actuator that applies a force between the interface surface and the base and is described in detail below. In some examples the retainer is a force redirector that changes the direction and/or magnitude of the force applied to the attachment by the orthodontic appliance. Examples of force redirectors are provided below. In any of these attachments the retainer may be separate from the actuator and/or force redirector. The retainer may be a lip region formed between the interface surface and the base, which allows relative movement between the two. In some examples the retainer is an elastic material that at least partially covers the interface surface and base, permitting relative movement between the two, but preventing them from separating. The retainer may be a housing or frame that prevents separation of the interface surface and base but allows them to move relative to each other.

The retainers described herein may have one or more (e.g., two or more, three or more, etc.) interconnected pieces or components. In some examples the retainer includes two pieces that are movably engaged with each other but that interlock to prevent separation.

### Force Applying Attachments

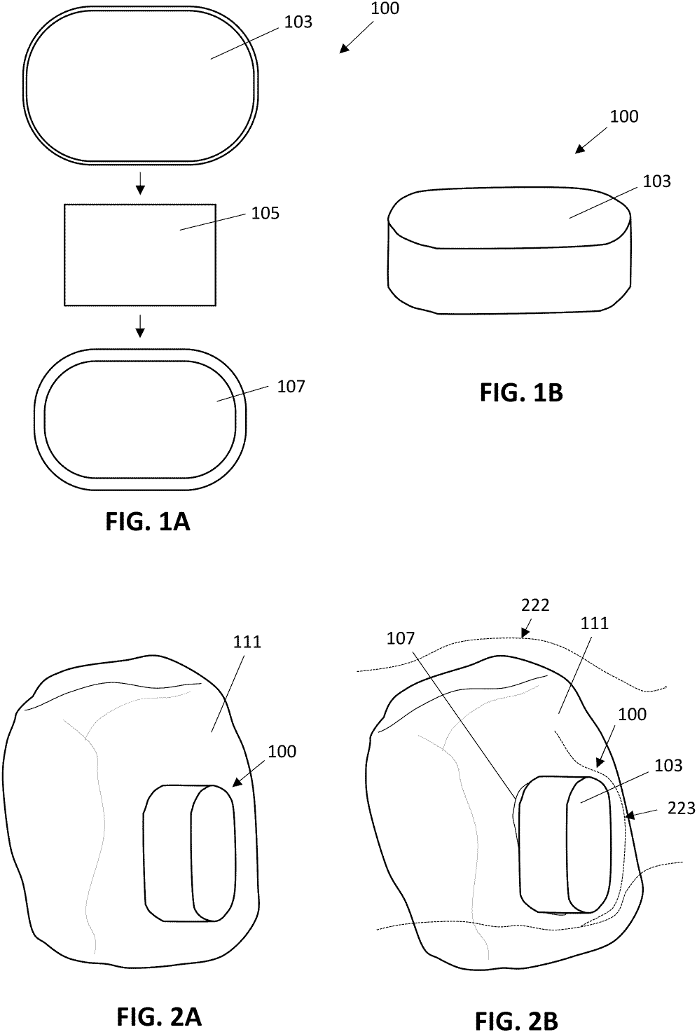

A force-applying attachment generally applies a force from an actuator (e.g., mechanical actuator) included as part of the structure of the attachment. The force may therefore be added to the force arising from the orthodontic appliance alone. Force may be applied by the force applying attachment when the aligner is coupled to the attachment. In some examples, the force applying attachment is actuated by the application of the orthodontic appliance (e.g., aligner) to the attachment(s); the orthodontic appliance may also support the attachment to allow for the additional application of force from the attachment. FIGS. 1A-1B, 2A-2B, 3A-3C, 4A-4C, and 5A-5B illustrate example of force-applying attachments. In general, these attachments may include a base that is configured to be rigidly affixed to the surface of a tooth or multiple teeth (e.g., between teeth), and an interface surface that is configured to engage with (e.g., couple to) an orthodontic appliance such as an aligner, and an actuator connecting the base to the interface surface. The actuator may apply a force (or forces) to the tooth or teeth through the base when the interface surface is engaged with the orthodontic appliance. The force applied by the actuator is not just the force due to the orthodontic appliance, but arises, at least in part, from the actuator. The actuator, which may be referred to herein as an actuator, is a force-generating component. Examples of actuators may include shape memory elements (e.g., nickel titanium alloys, such as Nitinol) that are configured to apply force against the base, springs, gears, piezoelectric actuators (e.g., bimorphs), solenoid (e.g., micro solenoid), or the like.

FIG. 1A is a schematic illustration of one example of a tooth attachment (“attachment”) including an actuator. In this example, the attachment 100 includes an interface surface 103, an actuator 105 and a base 107. The actuator 105 may be coupled to the base 107 and to the interface surface 103. The base and interface surface may be moveable relative to each other. In general, any of the attachments described herein may be configured so that the interface surface and base are moveable relative to each other, but are retained together, by a retainer, that holds them together so that they may be applied as a unitary attachment. In the example shown in FIG. 1A the actuator acts as the retainer, by connecting to both the interface surface and the base, while the base and interface surface are not rigidly connected together; movement of the actuator applies a force between the interface surface and the base, as the interface surface and base may move relative to each other, though may be constrained by the aligner, which is couped to the interface surface, and the base, which is rigidly coupled to the tooth (or teeth).

FIG. 1B shows an example of the attachment 100 of FIG. 1A fully assembled. The interface surface 103 is visible, and is shown having an oval cross-section, however the interface surface may be any appropriate shape that is configured to engage with the orthodontic appliance (e.g., aligner). The interface surface may be rigid or compliant, including elastic. The interface surface may be shaped to engage with an attachment-receiving region of the orthodontic appliance. The interface surface may be shaped to apply force from the orthodontic appliance to the base and therefore the tooth or teeth; this force may be added to the force applied by the actuator 105. The interface surface may be rounded, and may have a lobular shape, a teardrop shape, a notched shape, etc. Virtually any shape may be used; the shape of the interface surface may be configured to both engage with the orthodontic appliance and to transfer force(s) from the orthodontic appliance to the attachment and therefore to the tooth or teeth.

Although the actuator 105 shown schematically in FIG. 1A is illustrated as a single element, in some examples the actuator may include multiple portions (or may be divided into multiple actuators) that attach to different regions of the base. In any of the attachments described herein the base may be divided up into multiple, separate regions (or may be divided into multiple bases). Thus the attachment may include one or more actuators and/or one or more bases. In any of the attachments described herein the interface surface may include one or more regions (or may be divided into multiple interface surfaces). In some examples the actuator may include a single shape having a single or multiple facets (e.g., surfaces) that can be actuated in the desired direction throughout a treatment.

Thus, in some example, the same attachment may be configured to apply forces that have different magnitudes and/or directions (e.g., different force vectors), which may be applied at different regions of the tooth (or teeth) via the base. This may allow the attachment to drive movement of the tooth in rotation.

FIGS. 2A-2B illustrate the operation of an example of a force-applying attachment. In FIG. 2A the attachment 100 is shown bonded via a base 107 (not visible in FIG. 2A) to the outer surface of a tooth 111. In FIG. 2A the apparatus is shown prior to coupling to the orthodontic appliance. FIG. 2B shows the orthodontic appliance 222 applied over the tooth 111 and coupled with the interface surface 103 of the attachment 100, within an attachment-engaging region (e.g., pocket) 223 of the orthodontic appliance 222. In this example the attachment is configured so that the engagement of the attachment with the orthodontic appliance actuates an actuator (not visible in FIGS. 2A-2B) that is coupled to the interface surface 103 and the base 107, applying a force to the base 107. For example the attachment may include a bias or spring element that is attached within the attachment 100 between the base 107 and the interface surface 103, and which may apply a force driving movement of the tooth 111.

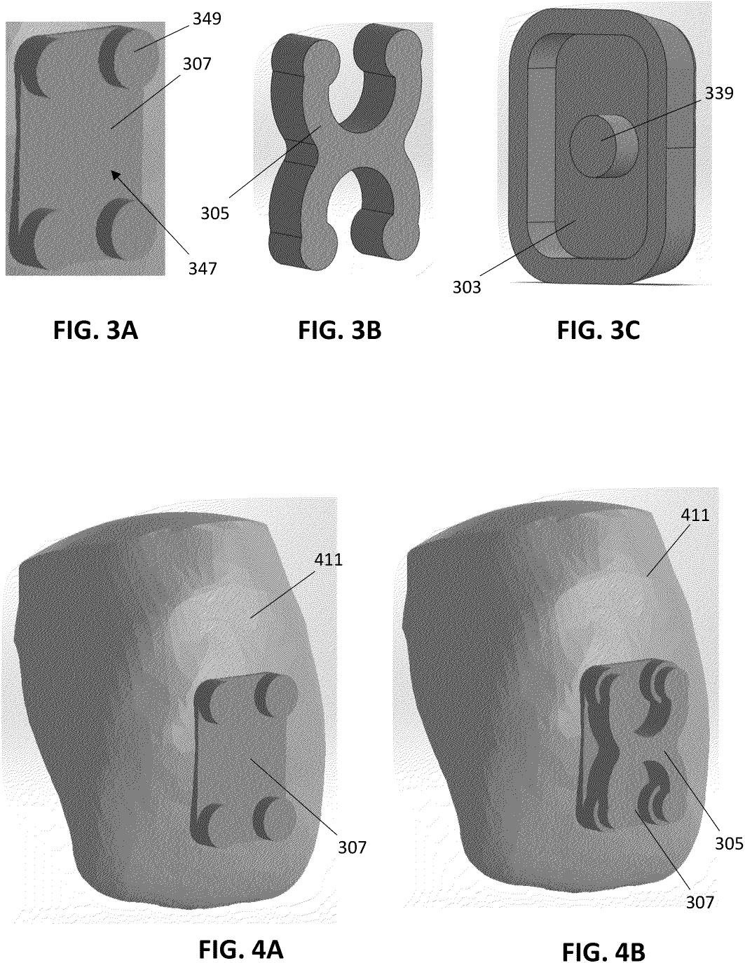

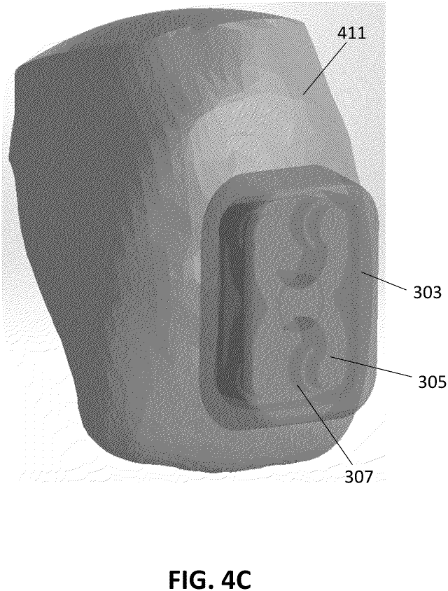

FIGS. 3A-3C illustrate other examples of component portions of a force-applying attachment. FIG. 3A shows an example of a base 307 that includes a tooth-facing side (not visible in FIG. 3A) and an internal side 347 that also includes one or more base coupling regions 349; in this example, four base coupling regions, or posts, are shown. FIG. 3B shows an example of an actuator 305 (e.g., mechanical actuator) that is formed of a shape-memory material, such as Nitinol, that is configured to have a shape and size to engage with the coupling region on the base, while another one or more portions of the actuator are configured to engage with interface surface 303. FIG. 3C shows an example of an interface surface 303 that also include an interface surface coupling region 339. The interface surface coupling region 339 may be coupled to the actuator either rigidly (e.g., glued, welded, bonded, etc.) or movably (e.g., snapped on, press-fit, pressed against, etc.). Similarly, the base coupling regions 349 may be coupled to the actuator either rigidly (e.g., glued, welded, bonded, etc.) or movably (e.g., snapped on, press-fit, pressed against, etc.). The base 307, actuator 305 and interface surface 303 may be assembled together to form a single attachment that may be bonded to the surface of the tooth or teeth. In some examples the attachment may be formed first and then bonded to the teeth; a guide or placement apparatus may be used to position the attachments on the teeth. In some examples the attachment may be assembled on the tooth or teeth. For example, in FIG. 4A, the base 307 of the attachment is shown bonded (via an adhesive, cement, etc.) to the outer surface of the tooth 411. As shown in FIG. 4B the actuator 305 is coupled to the base 307, and in FIG. 4C the interface surface 303 is coupled with the actuator 305 and, through the actuator 305, to the base 307. For example, the actuator (which in this example is a nickel titanium part) is mechanically attached or welded to the tooth base part and the aligner engagement part at their respective coupling regions.

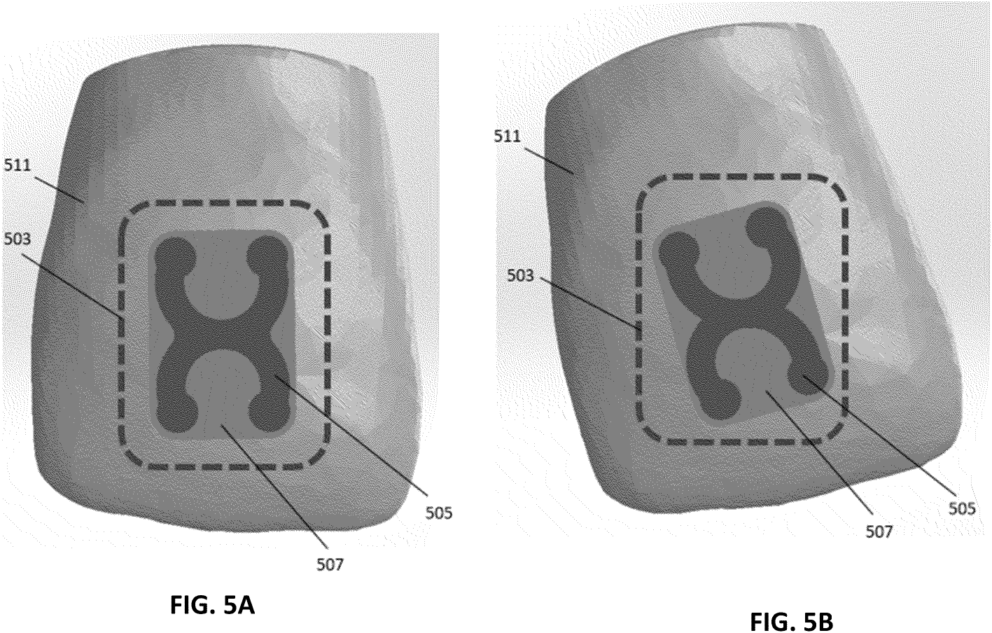

FIGS. 5A and 5B illustrate actuation of the attachment shown in FIGS. 3A-3C and 4A-4B. In FIG. 5A the actuator 505 is connected at multiple points (coupling regions) to the base 507 and is coupled to the interface surface 503 at a central region. The interface surface is not directly connected to the base. In FIG. 5B, actuating of the shape-memory actuator 505 changes its shape (e.g., transforming to a memorized shape), applying a force, in this example a rotational force, between the interface surface 503 and the base 507. If unconstrained by an orthodontic appliance, the interface surface may move relative to the tooth 511. However, when the attachment is coupled with and therefore constrained by the orthodontic appliance, the force applied by the actuator is applied to the tooth/teeth and may drive movement of the tooth/teeth. When the interface surface is engaged with the orthodontic appliance, regardless of the position and forces applied by the orthodontic appliance, the actuator 505 can be shaped to move tooth in another direction/orientation, including directions and forces that are not possible with the orthodontic appliance alone. In general, the actuator applies a force to change the relative positions of the interface surface to the base.

In some examples the actuator may include a bias (e.g., spring) element that may be loaded by coupling the attachment to the orthodontic appliance and may exert a restoring force against the tooth/teeth to drive movement of the tooth or teeth.

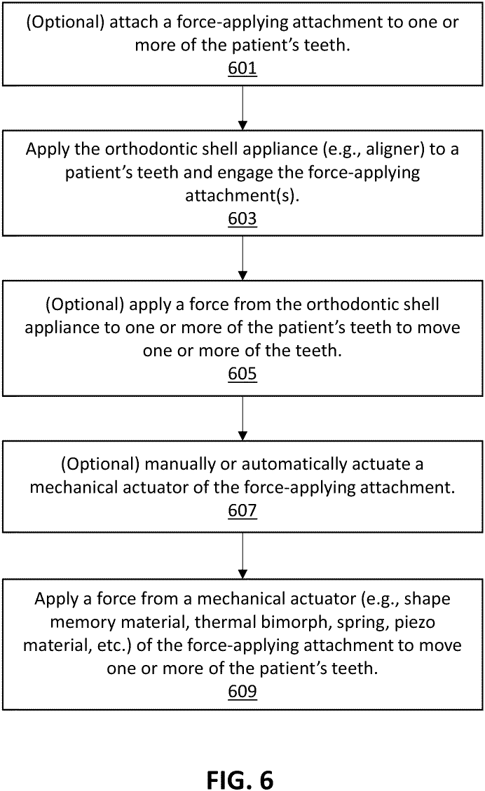

FIG. 6 illustrates one example of a method of using a force applying attachment to move a tooth (or teeth). In any of these methods, one or more force-applying attachments may be coupled to one or more of the patient’s teeth 601. This step may be performed by a dental professional (e.g., orthodontist, dental technician, etc.). The method may therefore begin after the force applying attachment(s) has/have been attached and one or a series of orthodontic appliances (e.g., aligners) have been fabricated and provided to the user in order to move the teeth, as part of a treatment plan. The treatment plan may be formed, including designed, to account for the forces applied to the teeth by the aligners and by the force-applying (and/or in some case force-redirecting) attachment(s). In particular, both the attachments and aligners may be selected or configured to apply a desired set of forces in order to move the patient’s teeth into a desired configuration (final or intermediate configuration).

For example, an orthodontic appliance, such as an aligner (e.g., shell aligner or orthodontic shell appliance) may be applied to the patient’s teeth so that a force-applying (and/or force redirecting) attachment is engaged with the aligner 603. In some examples, an aligner by itself may be configured to apply force(s) to move one or more of the patient’s teeth when worn 605. However, the force-applying attachments described herein may be configured for use with aligners that apply no or minimal force to move the teeth, as the force to drive movement of the teeth may arise from the attachment, which may be secured by the aligner (e.g., braced against the aligner). In some examples the aligner may be configured so that it does not, by itself, apply a significant force to the one or more teeth having a force-applying attachment, although the aligner may be configured to apply a force to another tooth or teeth to move them. In examples in which both the aligner and the attachment apply force to a tooth, the total movement of the tooth may be the result of the total forces, from both the aligner and the attachment applied to the tooth. This total force may be distributed over different portions of the tooth, which may allow translation by rotation, tilting, etc.

The force actuator may be manually or automatically actuated 607. For example, as mentioned above, the force actuator may include a spring element that is loaded by the engagement with the aligner. In some examples, the force actuator is actuated by a timed release, by application of an electrical and/or magnetic field, by thermal energy, by sonic (vibration) energy, etc. In any of the apparatuses described herein the apparatus may be triggered or actuated by an external signal, such as a chemical cue, e.g., pH, biochemical signal, or other actuating catalyst.

The attachment may then apply force from the actuator portion of the attachment to move one or more of the patient’s teeth 609. The force (or multiple forces) may be applied through the base (or base) region of the attachment.

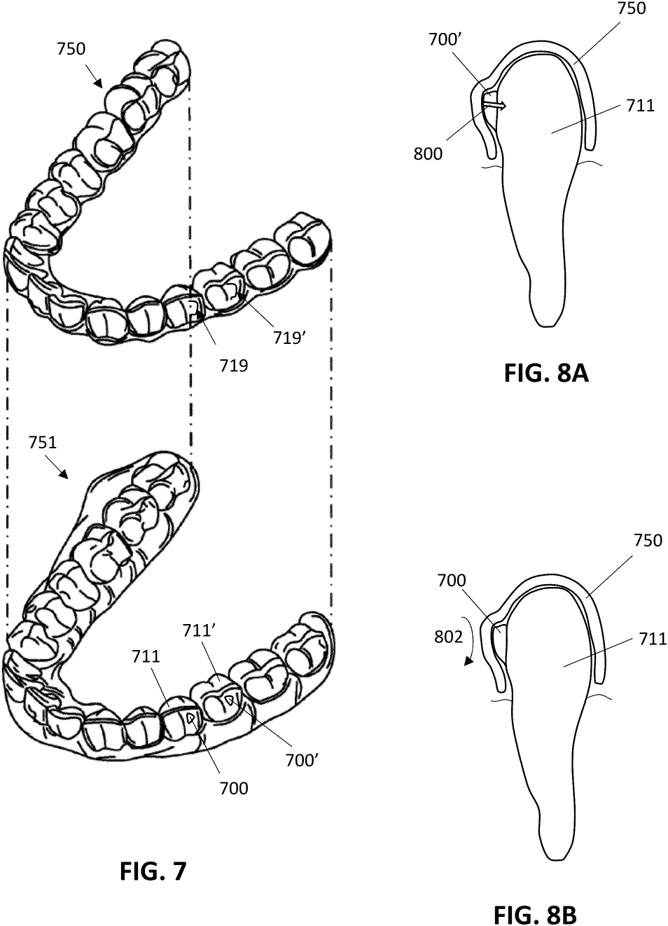

For example, FIG. 7 generally illustrates the attachment of an aligner 750 on a dental arch 751. In this example, two attachments 700, 700′ are shown on the teeth that may engage with the aligner. FIG. 7 illustrates an example of a method of attaching an orthodontic appliance (e.g., aligner) to a patient’s teeth to which one or more (two are shown) attachments are included. Either or both of the attachments may be force-applying (and/or force-redirecting) attachments as described herein. The aligner may engage with the attachments in an attachment-engaging region (e.g., pocket) 719, 719′ of the aligner. The aligner may be worn as part of a treatment plan to move teeth in a desired manner.

FIG. 8A shows an example of a passive attachment 700′ that does not include relative movement between a base and an interface surface (and does not include either an actuator or a force-redirector). In this case, the attachment 700′ may be a solid attachment that is bonded to the tooth 711 surface and engages with the aligner 750 so that a force 800 is applied by the aligner through the attachment 700′, shown here as a lingually directed force vector.

In FIG. 8B the attachment 700 is a force-applying aligner (and/or a force re-directing aligner) and the attachment applies a force 802 on the tooth. In this particular example the force is a rotational force 802 (similar to that shown in FIG. 2B) that may be configured to drive movement of the tooth in a directing in/out of the plane of the image shown. The interface surface of the attachment may move relative to the base, and when the interface surface is secured by the aligner, the resulting force may be applied on the tooth, resulting in repositing of the tooth. The aligner may be configured to provide support and engagement with the attachment as well as to provide space and support to allow the tooth to move in the desired direction (and may also include additional contact areas to facilitate the desired tooth movement, including applying one or more forces.

### Force Re-Directing Attachments

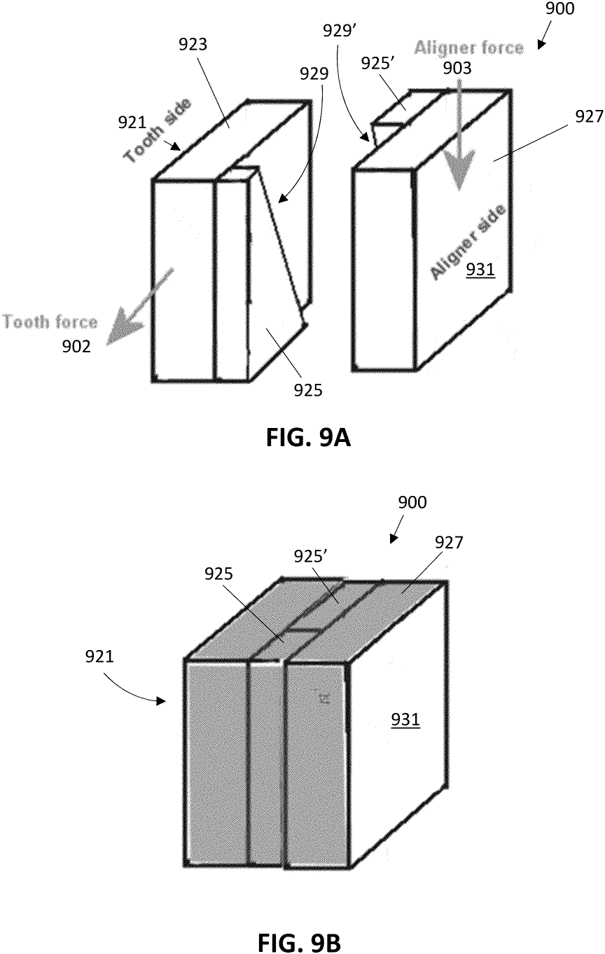

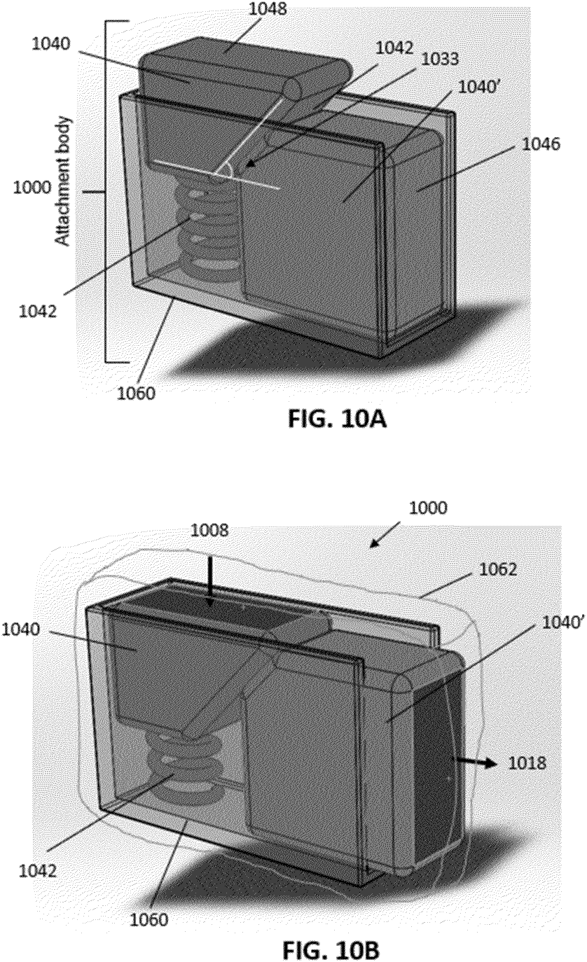

FIGS. 9A-9B, and 10A-10B illustrate examples of force redirecting (e.g., force diverting) attachments. In general, a force re-directing attachment may be configured very similarly to the force-applying attachment described above. A force re-directing attachment may, like the force-applying attachment, include a base and an interface surface that may move relative to each other. The base and the interface surface may be linked by a force redirector that may alter the direction (and/or magnitude) of force applied to the interface surface by an orthodontic appliance (e.g., aligner) engaged with the attachment. In general, the force redirector may include a force-redirecting surface so that the interface surface and base may move relative to each other along the force-redirecting surface.

For example, FIG. 9A shows one example of an attachment including a base 923 that is configured to rigidly attach to a tooth surface on a tooth attachment side 921 of the attachment. The attachment also includes an interface surface 927 that engages with the aligner (not shown) so that the aligner may apply a force (aligner force) 903 against the attachment. In this example the aligner force is shown directed generally down relative to the figure. The interface surface may include an aligner side 931 that may be shaped to engage with the aligner. The attachment also includes a two-part force redirector 925, 925′; the first part 925 is fixed to the base 923 and the second part 925′ is fixed to the interface surface 927, and a force redirecting surface 929 is formed between the two. For example the force redirector includes a first ramped force redirecting surface 929 on the base side of the force redirector that slidably engages with a second ramped force redirecting surface 929′ on the interface surface 927 side of the force redirector.

FIG. 9B shows an example of the attachment 900 of FIG. 9A assembled together. The base 923 is engaged with the interface surface 927 through the two-part force redirector 925, 925′. Other examples of force redirectors may include gears which translate a force vector from the interface surface into one or more force vectors applied to the base (or multiple base regions). The gearing surfaces may therefore act as a force-redirecting surface(s). In some examples the force redirector includes a lever or pivot that alters the direction of the force vector applied by the aligner. In some examples the force redirector includes a cam having a cam surface that acts as the force redirecting surface.

As mentioned above, any of the attachments described herein may also include a retainer (e.g., frame, housing, interface surface, or the like) that may hold the base portion and the housing portion together as a unitary attachment structure. For example, the interface surface may extend over the sides of the base portion and/or may include one or more lips or rails allowing the apparatus to engage with and secure the base and interface surface together (with the actuator and/or force redirector sandwiched therebetween). In some examples a flexible membrane may interface surface all or a portion of the base and the interface surface to allow relative movement between the two, but to hold them together.

FIGS. 10A-10B schematically illustrate another example of an attachment as described herein. In FIG. 10A, the attachment 1000 includes a force redirector 1040, 1040′ formed from two blocks having a force redirecting surface 1042 between the two, so that the first portion of the force redirector 1040 and the second portion of the force redirector 1040′ may slide relative to each over the force-redirecting surface. In this example the angle of the force-redirecting surface is shown as a 45 degree angle so that a vertical force (e.g., a downward aligner force 1008) results in an approximately equal horizontal force 1018, as shown in FIG. 10B. The angle 1033 between the first portion of the force redirector 1040 and the second portion of the force redirector 1040′ may be adjusted to change the direction of the redirected force. In FIG. 10A the force redirector also includes a bias 1042 (shown here as a spring) that may apply a restoring force to reset the force director if the force applied by the aligner changes, or if a second aligner is used with the same attachment.

In FIGS. 10A and 10B the attachment may be configured so that one portion of the force redirector, such as an outer surface 1046 of the second portion of the force redirector 1040′ is configured to couple to a base or may be adapted to form the base and be affixed to the surface of a tooth. Similarly an upper surface 1048 of the first portion of the force redirector 1040 may be configured to engage with the aligner. The attachment may also include a separate retainer 1060 that retains the force redirector and/or the base and interface surface.

In some examples the attachment may include an outer retainer 1062 that may be, e.g., an elastomeric material that allows relative movement of the first portion of the force redirector 1040 and the second portion of the force redirector 1040′, and therefore the base and interface surface, as shown in FIG. 10B. In some examples the force-redirector may redirect all or a portion of the force applied by the aligner to modify the shape of the attachment portion that is coupled to a different region of the aligner. For example, in FIGS. 10A-10B, the outer surface of the second portion of the force redirector 1040′ may instead be coupled to the aligner. Thus, the application of vertical force by the aligner may be transformed by the force-redirector into a horizontal force on a different part of aligner pocket. This may change the overall force magnitude and/or direction applied by the aligner on to the teeth.

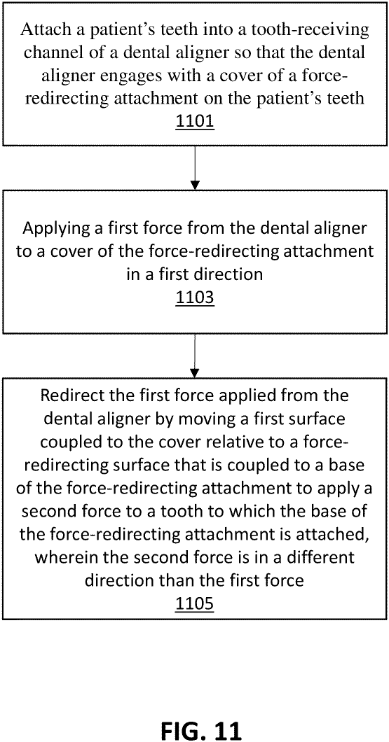

FIG. 11 illustrates one example of a method of using a force re-directing attachment to move a tooth (or teeth). In FIG. 11, an aligner may be coupled to an attachment including a force redirector that is attached to the patient’s tooth or teeth 1101. The aligner may be attached so that the patient’s teeth fit into a tooth-receiving channel or cavity of the dental aligner so that the dental aligner engage with the attachment (e.g., with an interface surface of the force-redirecting attachment on the patient’s tooth or teeth.

The aligner may apply a first force against the attachment 1103, such as by applying the first force to the interface surface region of the attachment. In general, the force redirector may allow the base to move relative to the interface surface so that the force applied by the aligner to the interface surface is redirected at a different angle and/or magnitude to the base. For example, the force-redirector of the attachment may then redirect the first force applied from the dental aligner by moving a first surface coupled to the interface surface relative to a force-redirecting surface that is coupled to a base of the force-redirecting attachment to apply a second force to a tooth to which the base of the force-redirecting attachment is attached 1105. The second force may be in a different direction than the first force.

In general, the apparatuses described herein may be applied to the subject’s teeth using a jig or attachment frame. For example, the attachments (e.g., active attachments) may be preassembled and coupled to a frame that is applied to the teeth to attach the base of the one or more attachments to a predetermined location on the teeth. The frame may be configured to be applied to the teeth so that, when applied, the attachments are positioned against the teeth in the predetermined location and/or orientation. In some examples the frame is a wire frame. In some examples the frame is shaped like an aligner that fits over the teeth when the teeth are in a particular stage of a treatment plan, or at the start of a treatment plan.

In some examples the frame or jig includes just the base portion of each attachment and the other components (e.g., the orthodontic appliance engaging region, such as an interface surface, and the actuator) may be applied after the base is attached to the subject’s teeth. The frame or jig may be formed concurrently with the base and/or other portions of the active attachments. For example the frame and/or jig may be formed with the base as part of a 3D printing process.

In use, the frame or jig holding all, or a portion of the active attachments may be inserted into a subject’s mouth so that the jig holds the base of each attachment in the desired position. An adhesive/cement material may be applied first or may be applied once the frame/jig is applied to the teeth. The frame or jig may also include a light source or light channel for crosslinking a light-reactive cement. Once the active attachments (or at least the base portion of each active attachment) is bonded to the teeth, it may be removed. In some examples additional frames/jigs may be worn sequentially to apply additional attachments (passive and/or active attachments) or in some examples to attach the other part(s) of the active attachments, such as the actuator and the orthodontic appliance engaging region (e.g., interface surface).

### Modular Attachments

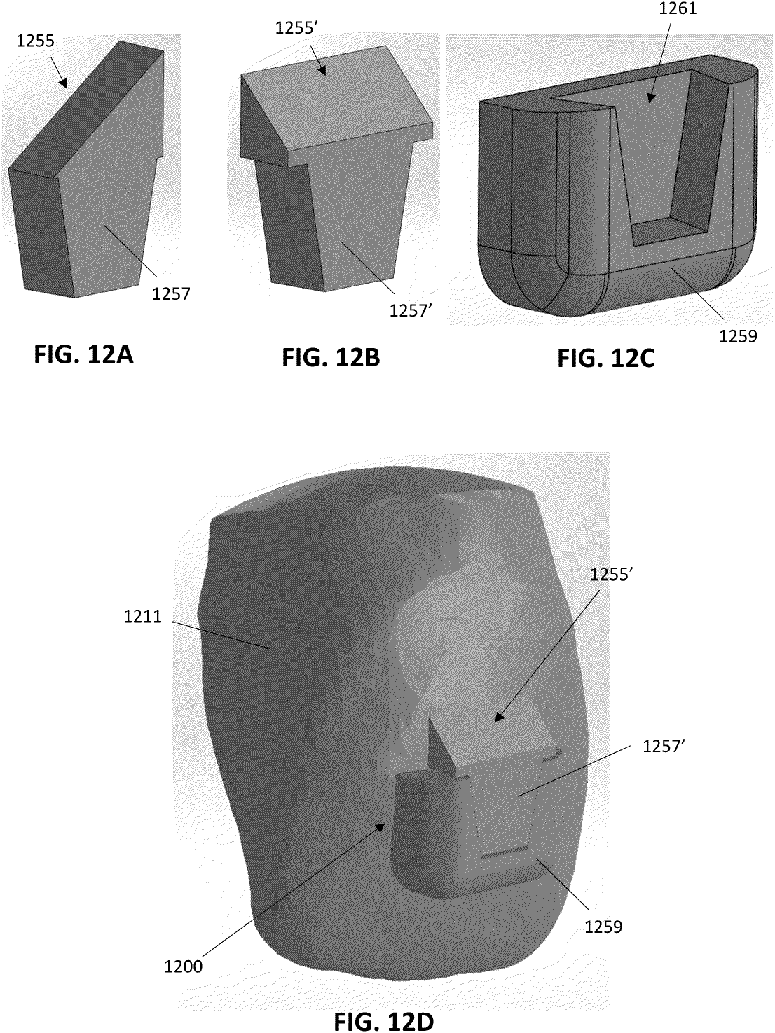

Also described herein are modular attachments that are formed of multiple parts that may be coupled together (and may be swapped out) to form attachments having different properties including different resulting force angles. FIGS. 12A-12D, 13A-13C and 14A-14C illustrate examples of modular attachments. In general, modular attachments may allow the same base region, which may be bonded to the patient’s tooth or teeth, to be used within multiple different interface surface regions (e.g., regions configured to engage with and receive forces from the aligner).

FIGS. 12A-12D illustrate a first example of a modular attachment 1200 that includes a base region 1259 that is configured to be coupled to a tooth, such as bonded to the tooth, as shown in FIGS. 12C and 12D. The base 1259 may include a pocket or compartment 1261 for securing an interface surface region 1257, 1257′ such as the one shown in either FIG. 12A or FIG. 12B; either of these interface surface regions 1257, 1257′ may be used with the same base 1259. For example, if the interface surface region 1257 shown in FIG. 12A is used, the interface surface 1255 is oriented at an angle that is perpendicular to the face of the tooth. The interface surface region 1255′ of the second interface surface 1257′ is oriented at a different angle and direction and will therefor redirect the force from the aligner to the tooth in a different direction.

In any of these examples the base and interface surface regions may be lockably engaged with each other to prevent them from being removed unintentionally, including preventing them from falling out.

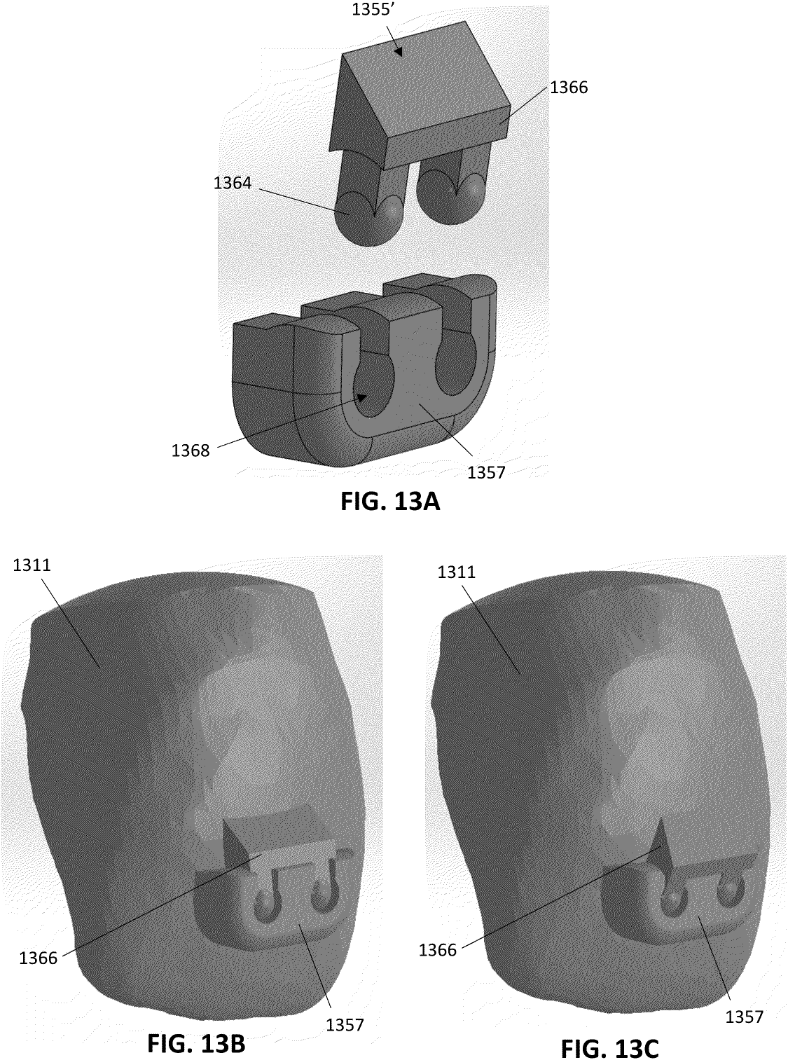

Some of the modular attachments described herein may be adjustable, so that the interface surface portion of the attachment (e.g., the portion of the attachment configured to engage with and receive force from the aligner) may be adjustably coupled to the base 1357 (attached to the tooth 1311), as shown in FIGS. 13A-13C. In this example the interface surface portions each includes a pair of adjustable couplers 1364 that may receive and engage a corresponding coupler receivers 1368 in the base 1357. As shown in FIGS. 13B and 13C, the angle 1355′ of the interface surface (“activation angle”) that engages with and receives force from the aligner may be adjusted by adjusting the angle in which the interface surface portion 1366 is engaged with the base portion 1357.

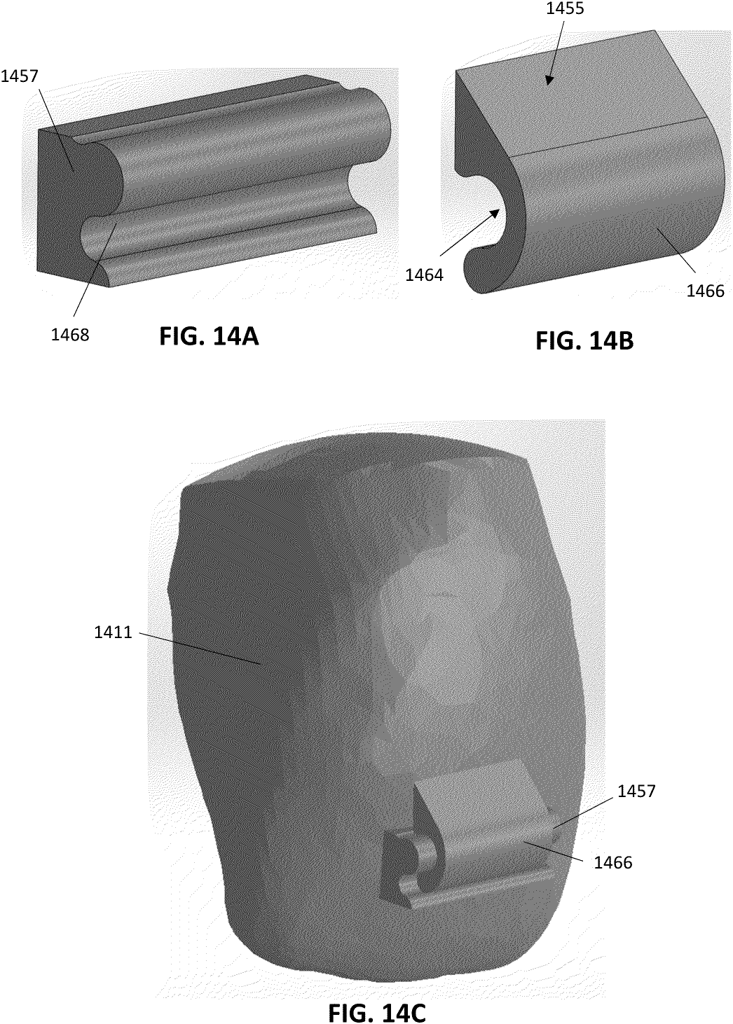

FIGS. 14A-14C illustrate another example of a base portion 1457 that may bond to a tooth 1411 and provide a secure attachment for an interface surface portion 1466 (in some case irreversibly attaching to the interface surface portion). FIG. 14A shows an example of a base portion 1457 including a coupler receiver region 1468 that may engage with a corresponding coupler region 1464 of an interface surface portion 1466. FIG. 14B shows one example of an interface surface region 1466 having a surface 1455 that engages with and receives force from an aligner. Alterative interface surface portions may be used that may interchangeably engage with a base portion. FIG. 14C shows an example of an assembled modular attachment. In some examples the same base portion 1457 may be used with different interface surface portions 1466, as also described in FIGS. 12A-12C and 13A-13C.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An attachment for an orthodontic appliance, the attachment comprising:
a base configured to be rigidly mounted to a tooth surface;
an interface surface movably coupled to the base, wherein the interface surface comprises an outer surface configured to removably engage with an orthodontic appliance to be worn on a patient’s teeth; and
a retainer securing the base and the interface surface together while permitting movement of the interface surface relative to the base, wherein a force applied to the interface surface from the orthodontic appliance is transformed by the relative movement of the interface surface and the base.

2. The attachment of claim 1, wherein the retainer comprises an actuator, wherein the actuator is coupled to the base and to the interface surface, further wherein actuating the actuator moves the interface surface relative to the base.

3. The attachment of claim 2, wherein the actuator comprises one or more of: a shape-memory material, one or more gears, a spring, a thermal bimorph, and a piezoelectric.

4. The attachment of claim 2, wherein the actuator is movably coupled to the base.

5. The attachment of claim 2, wherein the actuator is movably coupled to the interface surface.

6. The attachment of claim 1, wherein the retainer comprises a force redirector between the base and the interface surface, wherein the base is movably coupled to the interface surface through the force-redirector so that a first force applied against the interface surface by the orthodontic appliance is redirected by the force-redirector so that it is applied as a second force against the base or the interface surface in a different direction than the first force.

7. The attachment of claim 6, wherein the force redirector comprises a force redirecting surface.

8. The attachment of claim 6, wherein the force redirector comprises a ramp.

9. The attachment of claim 6, wherein the force redirector comprises a cam surface.

10. The attachment of claim 6, wherein the force redirector comprises a lever.

11. The attachment of claim 6, wherein the force redirector comprises one or more gears.

12. The attachment of claim 6, further comprising a bias coupled to the force redirector to modify the first force.

13. The attachment of claim 1, wherein the outer surface comprises a rigid outer housing that is configured to engage with an engagement site on the orthodontic appliance.

14. The attachment of claim 1, wherein the orthodontic appliance comprises a shell aligner.

15. An attachment for an orthodontic appliance, the attachment comprising:
a base configured to be rigidly mounted to a tooth surface;
an actuator coupled to the base; and
an interface surface coupled to the actuator, wherein the interface surface comprises an outer surface configured to removably engage with an orthodontic appliance to be worn on a patient’s teeth, further wherein actuating the actuator moves the interface surface relative to the base.

16. The attachment of claim 15, wherein the actuator comprises a shape-memory material.

17. The attachment of claim 15, wherein the actuator comprises a nitinol member.

18. The attachment of claim 15, wherein the actuator comprises one or more gears.

19. The attachment of claim 15, wherein the actuator comprises one or more of: a spring, a thermal bimorph, and a piezoelectric.

20. The attachment of claim 15, wherein the actuator is movably coupled to the base.

21. The attachment of claim 15, wherein the actuator is movably coupled to the interface surface.

22. The attachment of claim 15, further comprising one or more bearing surfaces within either or both the interface surface and the base.

23. The attachment of claim 15, wherein the outer surface comprises a rigid outer housing that is configured to engage with an engagement site on the orthodontic appliance.

24. The attachment of claim 15, wherein the orthodontic appliance comprises a shell aligner.

25-79. (canceled)
